(19) United States
(12) Patent Application Publication
(10) Pub. No.: US 2008/0281447 A1
(43) Pub. Date: Nov. 13, 2008

(54) WIRELESS EARPHONE, AUDIO PLAYER, AND AUDIO PLAYING METHOD

(75) Inventors: Fang-Hua Liu, Shenzhen (CN); Biao-Geng Zhong, Shenzhen (CN); Bi-Qing Luo, Shenzhen (CN); Shih-Fang Wong, Tu-Cheng (TW); Xin Lu, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/936,764

(22) Filed: Nov. 7, 2007

(30) Foreign Application Priority Data
May 11, 2007 (CN) 200710200605.5

(51) Int. Cl. G06F 17/00; H04R 5/033

(52) U.S. Cl. 700/94; 381/380

(57) ABSTRACT

A wireless earphone is provided herein. The wireless earphone includes a transceiver, a storage unit, a playing unit, and a speaker. The transceiver is for wirelessly receiving a compressed audio file. The storage unit is for storing the compressed audio file. The playing unit is for decoding the compressed audio file stored in the storage unit, and transforming the decoded audio file into analog audio signals. The speaker is for transforming the analog audio signals into sound. An audio player and an audio playing method are also provided.

### BACKGROUND

1. Field of the Invention

The present invention relates to a method and apparatus for playing audio files using a wireless earphone.

2. Description of Related Art

Portable audio players such as moving pictures experts group-1 Audio Layer 3 (MP3) players, music phones, etc are now very popular and commonly used. These portable audio players typically include electro-acoustic transducers for converting electric signals into sounds such as earphones or headphones. Usually the portable audio player is used to decode audio files into analog audio signals, and then transmit the analog audio signals to the earphones, which then transform the analog audio signals into sound. There are two types of earphones, e.g. a wired type and a wireless type. Typically, a wired earphone includes left and right earplugs, and wires or cables for attaching the earplugs to the audio player and for receiving transmission of the decoded audio files from the audio player. However, in use, the wires or cables are prone to becoming tangled and cumbersome to the user.

To resolve the above mentioned problem, wireless earphones can be used. A pair of transceivers is respectively set in the audio player and the wireless earphone. The audio player decodes a compressed audio file and then wirelessly transmits the decoded audio file to the wireless earphone via the two transceivers. The wireless earphone then transforms the decoded audio file into sound.

However, there are also some problems. The size of the decoded audio file is normally very large, and wireless transmission is much slower than wired transmission, so the sound the user hears may be intermittent or discontinuousness. Further, the wireless transmission may be interfered with by other signals.

### SUMMARY

A wireless earphone is provided herein. The wireless earphone includes a transceiver, a storage unit, a playing unit, and a speaker. The transceiver is for wirelessly receiving a compressed audio file. The storage unit is for storing the compressed audio file. The playing unit is for decoding the compressed audio file stored in the storage unit, and transforming the decoded audio file into analog audio signals. The speaker is for transforming the analog audio signals into sound. An audio player and an audio playing method are also provided.

Other devices, methods, features, and advantages of the present wireless earphone, audio player, and audio playing method will become apparent to one with ordinary skill in the art upon examination of the following drawings and detailed description. It is intended that all such additional devices, methods, features, and advantages be included within this description, be within the scope of the present invention, and be protected by the accompanying claims.

### BRIEF DESCRIPTION OF THE DRAWINGS

Many aspects of the present wireless earphone, audio player, and audio playing method can be better understood with reference to the following drawings. The components in the drawings are not necessarily to scale, emphasis instead being placed upon clearly illustrating the principles of the present invention. Further, in the drawings, like reference numerals designate the same parts throughout the several views.

FIG. 1 illustrates a communications architecture diagram including schematic figures of an audio player and wireless earphones in accordance with an aspect of the present invention.

FIG. 2 illustrates a block diagram showing an audio player in accordance with an aspect of the present invention.

FIG. 3 illustrates a block diagram showing a wireless earphone in accordance with an aspect of the present invention.

FIG. 4 illustrates a flowchart of an exemplary process of an audio playing method in accordance with an aspect of the present invention.

### DETAILED DESCRIPTION OF THE EMBODIMENTS

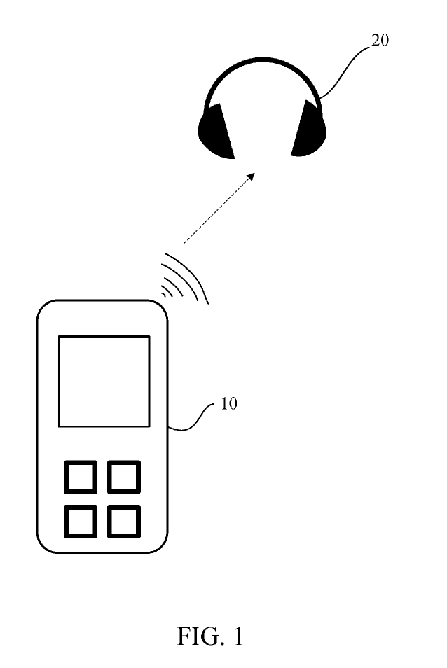

FIG. 1 illustrates a communications architecture diagram including schematic figures of an audio player 10 and wireless earphones 20 wirelessly communicating with the audio player 10. It should be noted that any wireless electro-acoustic transducer for converting electric signals into sounds may be used and that earphones/headphones are depicted here by way of example. The audio player 10 is capable of reading a compressed audio file from a storage medium, wirelessly transmitting the compressed audio file to the wireless earphones 20, and remotely controlling the wireless earphones 20. The wireless earphones 20 are capable of receiving the compressed audio file, playing the compressed audio file under control of the audio player 10, and feeding back playing information to the audio player 10. The playing information may include a name, a playing state, a playing rate, timing information, and volume information of the compressed audio file, which is currently playing.

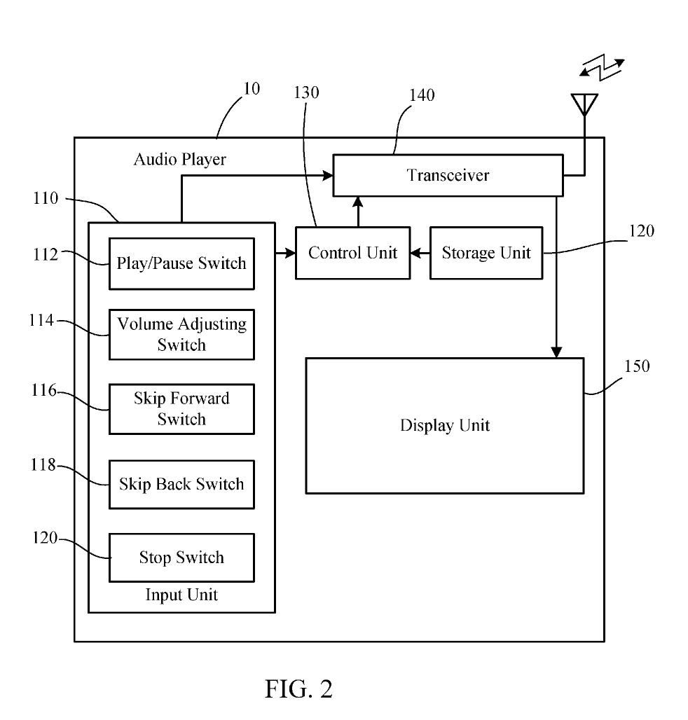

Referring to FIG. 2, a block diagram of the audio player 10 is shown. The audio player 10 includes an input unit 110, a storage unit 120, a control unit 130, a transceiver 140, and a display unit 150.

The input unit 110 is for generating control signals according to operations of a user. The control signals are then transmitted to the control unit 130 and the wireless earphones 20. In the embodiment, the input unit 110 includes a play/pause switch 112 for generating a play signal when the play/pause switch 112 is pressed an odd number of times, a volume adjusting switch 114 for generating a volume adjusting signal, a skip forward switch 116 for generating a skip forward signal, a skip back switch 118 for generating a skip back signal, and a stop switch 120 for generating a stop signal. A pause signal will be generated when the play/pause switch 112 is pressed down for an even number of times time.

The storage unit 120 is for storing compressed audio files in various formats, such as mp3, RealMedia, and Windows Media.

The control unit 130 is for reading one of the compressed audio files from the storage unit 120, and transmitting the read compressed audio file to the wireless earphones 20 via the transceiver 140. In the embodiment, the control unit 130 reads and transmits the compressed audio files according to the play signal, reads and transmits a next compressed audio file according to the skip forward signal, and reads and transmits a previous compressed audio file according to the skip back signal.

The transceiver 140 is for wirelessly communicating with the wireless earphone 20. In detail, the transceiver 140 transmits the control signals and the compressed audio file to the wireless earphones 20, and receives the playing information from the wireless earphones 20. The transceiver 140 may use wireless fidelity (Wi-Fi) protocol, bluetooth protocol, etc.

The display unit 150 is for displaying the playing information received from the wireless earphones 20.

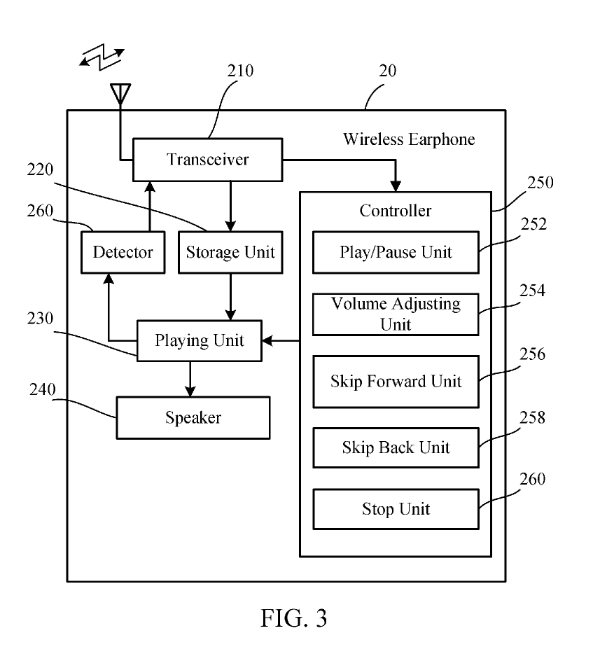

Referring to FIG. 3, a block diagram of one of the wireless earphones 20 is shown. The wireless earphone 20 includes a transceiver 210, a storage unit 220, a playing unit 230, a speaker 240, a controller 250, and a detector 260.

The transceiver 210 is for wirelessly communicating with the transceiver 140 of the audio player 10. In detail, the transceiver 210 receives the control signals and the compressed audio file from the transceiver 140, and transmits the playing information to the transceiver 140.

The storage unit 220 is for storing the compressed audio file (may be the one of the compressed audio files, the next compressed audio file, or the previous compressed audio file) from the audio player 10. The playing unit 230 is for playing the compressed audio file stored in the storage unit 220. In anther words, the playing unit 230 decodes the compressed audio file, and then transforms the decoded audio file into analog audio signals. The speaker 240 is for transforming the analog audio signals into sound.

The controller 250 is for controlling the playing unit 230 according to the control signals. The controller 250 includes a playing/pausing unit 252, a volume adjusting unit 254, a skip forward unit 256, a skip back unit 258, and a stopping unit 260. The playing/pausing unit 252 is for enabling the playing unit 230 to play the compressed audio file according to the play signal, and for signaling the playing unit 230 to pause the play according to the pause signal. The volume adjusting unit 254 is for adjusting an amplitude of the analog audio signals according to the volume adjusting signal, thus, adjusting the volume of sound output from the speaker 240. The skip forward unit 256 is for controlling the playing unit 230 to play the next compressed audio file according to the skip forward signal. The skip back unit 256 is for controlling the playing unit 230 to play the previous compressed audio file according to the skip back signal. The stopping unit 258 is for disabling the playing unit 230 according to the stop signal.

The detector 260 is for automatically acquiring the playing information from the playing unit 230, and transmitting the playing information to the audio player 10 via the transceiver 260.

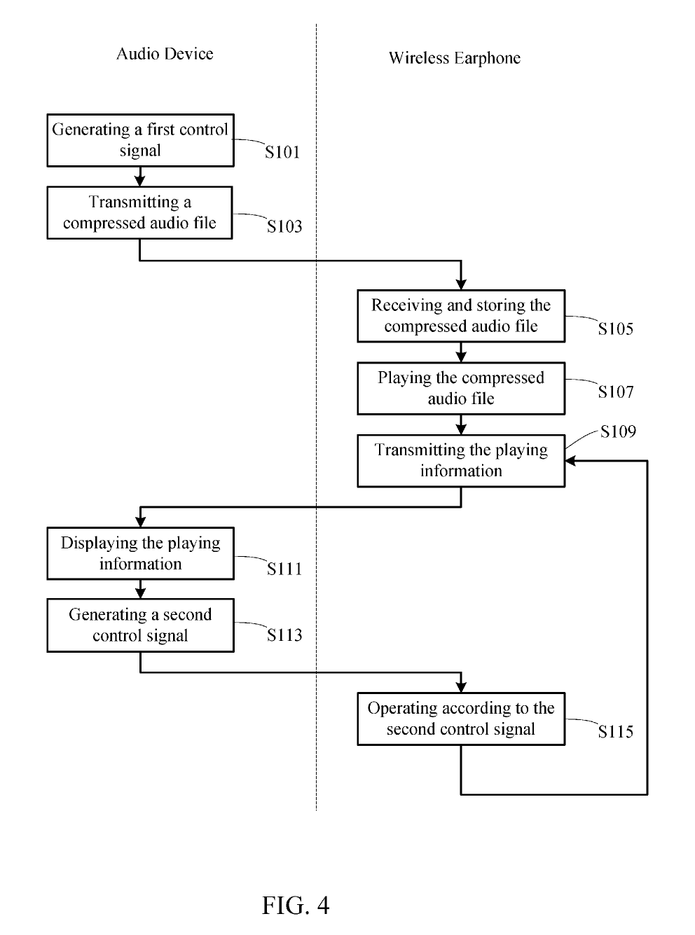

Referring to FIG. 4, a process flow chart 100 for an audio playing method is shown. The audio playing method is applied in an audio player with a wireless earphone. The audio playing method includes the following steps.

In step S101, the audio player generates a first control signal when a user presses a play/pause switch (a first operation of the user). The first control signal may be a play signal.

In step S103, the audio player reads and wirelessly transmits a compressed audio file to the wireless earphone when the first control signal is play, skip forward, or skip back signal.

In step S105, the wireless earphone receives the compressed audio file, and stores the compressed audio file in a storage unit.

In step S107, the wireless earphone decodes the compressed audio file stored in the storage unit, transforms the decoded audio file into analog audio signals, and transforms the analog audio signals into sound.

In step S109, the wireless earphone wirelessly transmits the playing information to the audio player. The playing information comprises a name, a playing state, a playing rate, timing information, and volume information of the compressed audio file currently playing.

In step S111, the audio player displays the playing information.

In step S113, the audio player generates a second control signal according to a second operation of the user, and transmits the second control signal to the wireless earphone. The second control signal may be one of the play signal, the pause signal, the volume adjusting signal, the skip forward signal, the skip back signal and the stop signal.

In step S115, the wireless earphone operates according to the second control signal. The playing unit may play the compressed audio file, pause the playing operation, adjust the volume, play a next compressed audio file, play a previous compressed audio file, or stop playing the compressed audio file which is currently playing according to the second control signal.

As described above, the compressed audio file can be transmitted wirelessly to the wireless earphone, stored, and played by the wireless earphone. Thus avoiding intermittent or discontinuous sound. Because the size of the compressed audio file is much smaller than that of a decoded audio file, time spent to transmit the compressed audio file is much shorter than would be spent to transmit the decoded audio file. The possibility of interference to the transmission by other signals is greatly reduced.

It should be emphasized that the above-described preferred embodiment, is merely a possible example of implementation of the principles of the invention, and is merely set forth for a clear understanding of the principles of the invention. Many variations and modifications may be made to the above-described embodiment of the invention without departing substantially from the spirit and principles of the invention. All such modifications and variations are intended to be included herein within the scope of this disclosure and the present invention and be protected by the following claims.

What is claimed is:

1. A wireless earphone, comprising:
a transceiver for wirelessly receiving a compressed audio file;
a storage unit for storing the compressed audio file; and
a playing unit for decoding the compressed audio file stored in the storage unit, and
transforming the decoded audio file into analog audio signals, and
a speaker for transforming the analog audio signals into sound.

2. The wireless earphone according to claim 1, further comprising a controller for controlling the playing unit according to a control signal received via the transceiver, wherein the control signal is one of the following: a play signal, a pause signal, a volume adjusting signal, a skip forward signal, a skip back signal, and a stop signal.

3. The wireless earphone according to claim 1, further comprising a detector for acquiring playing information from the playing unit, and transmitting the playing information via the transceiver, wherein the playing information comprises a name, a playing state, a playing rate, timing information, and volume information of the compressed audio file.

4. An audio player, comprising:
an input unit for generating a control signal;
a storage unit for storing a compressed audio file;
a transceiver for wirelessly transmitting the compressed audio file; and
a control unit for enabling the transceiver according to the control signal.

5. The audio player according to claim 4, wherein the control unit is also for transmitting the control signal.

6. The audio player according to claim 4, wherein the transceiver is also for wirelessly receiving playing information.

7. The audio player according to claim 6, further comprising a display unit for displaying the playing information.

8. An audio playing method, comprising:
wirelessly receiving a compressed audio file;
storing the compressed audio file;
decoding the compressed audio file;
transforming the decoded audio file into analog audio signals, and
transforming the analog audio signals into sound.

9. The audio playing method according to claim 8, further comprising:
generating a first control signal;
wirelessly transmitting the compressed audio file according to the first control signal.

10. The audio playing method according to claim 8, further comprising:
wirelessly transmitting playing information, wherein the playing information comprises a name, a playing state, a playing rate, timing information, and volume information of the compressed audio file.

11. The audio playing method according to claim 10, further comprising:
displaying the playing information.

12. The audio playing method according to claim 8, further comprising:
generating a second control signal;
wirelessly transmitting the second control signal, wherein the second control signal is one of the following: a play signal, a pause signal, a volume adjusting signal, a skip forward signal, a skip back signal, and a stop signal.

13. The audio playing method according to claim 12, further comprising:
wirelessly receiving the second control signal;
performing one of the following steps according to the second control signal: playing the compressed audio file, pausing play of the compressed audio file, adjusting volume, playing a next compressed audio file, playing a previous compressed audio file and stop playing of the compressed audio file.
